(19) United States
(12) Patent Application Publication
(10) Pub. No.: US 2011/0162359 A1
(43) Pub. Date: Jul. 7, 2011

(54) DEVICE FOR SEALING A BEARING HOUSING OF AN EXHAUST-GAS TURBOCHARGER

(75) Inventors: Dominique BOCHUD, Wettingen (CH); Tobias Gwehenberger, Rheinfelden (CH); Joel Schlienger, Zurich (CH); Christoph Häge, Wettingen (CH)

(73) Assignee: ABB TURBO SYSTEMS AG, Baden (CH)

(21) Appl. No.: 13/049,370

(22) Filed: Mar. 16, 2011

Related U.S. Application Data
(63) Continuation of application No. PCT/EP2009/056171, filed on May 20, 2009.

(30) Foreign Application Priority Data
Sep. 18, 2008 (EP) 08164600.2

(51) Int. Cl. F16J 15/44; F02C 6/12

(52) U.S. Cl. 60/605.1; 277/411

(57) ABSTRACT

The device serves for sealing a bearing housing of an exhaust-gas turbocharger, from which a rotor is led into a chamber of the turbocharger subjected to a mass flow. The device includes a sealing ring arranged in a groove of the rotor, a seat, arranged on the bearing housing and on which a pre-stressed sealing ring is secured by an outward-facing circumferential surface, and a radially extending separation gap, which leads annularly around the axis of rotation of the rotor and is defined by two superimposed sliding surfaces, the first of which is arranged on a first face of the sealing ring and the second of which is arranged on a first flank of the groove. In order to reduce a heat input into the sealing ring caused by lapping of the sealing ring during operation of the exhaust-gas turbocharger, a depression annularly around the axis is formed into the second flank of the groove. The depression is defined radially outwards by an annular body formed into the rotor. The annular body forms a portion of an external face of the rotor. The annular body includes a radially oriented annular edge, which adjoins the external face and which serves to reduce the size of a lapping face, which is produced as the sealing ring strikes against the second groove flank.

### RELATED APPLICATIONS

This application claims priority as a continuation application under 35 U.S.C. §120 to PCT/EP2009/056171, which was filed as an International Application on May 20, 2009 designating the U.S., and which claims priority to European Application 08164600.2 filed in Europe on Sep. 18, 2008. The entire contents of these applications are hereby incorporated by reference in their entireties.

### FIELD

The disclosure relates to the field of exhaust-gas turbochargers, to a device for sealing a bearing housing of an exhaust-gas turbocharger and to an exhaust-gas turbocharger having such a device.

### BACKGROUND INFORMATION

In an exhaust-gas turbocharger, the exhaust gases of an internal combustion engine are used for the compression of combustion air delivered to the internal combustion engine. For this purpose the turbocharger includes a rotor having a turbine and a compressor, which are seated on a common shaft of the rotor. The exhaust gases of the internal combustion engine are expanded in the turbine and converted into rotational energy. The rotational energy obtained is transmitted by the shaft to the compressor, which compresses the air delivered to the internal combustion engine. Using the energy of the exhaust gases to compress the air delivered to the combustion process in the internal combustion engine can make it possible to optimize the combustion process and the energy efficiency of the internal combustion engine.

A portion of the rotor is rotatably guided in a bearing housing on axial and radial bearings, which are lubricated by a lubricant, for example, oil. In order to prevent the lubricant leaking out towards the turbine or the compressor, the portion of the rotor supported in the bearing housing can be led out of the bearing housing via two seals, of which one seals off the bearing housing from the turbine and the other seals it off from the compressor.

The bearing housing of the exhaust-gas turbocharger holding the lubricant can be sealed off from the turbine shaft by a sealing ring embodied as a piston ring, which can be arranged with axial and radial play in an annular groove of the rotor led around the axis of rotation of the rotor, and which can be clamped under pre-stressing in a seat of the bearing housing. According to a desired specification, it is also possible to provide two or more sealing rings, which can generally likewise be each embodied as piston rings and can each be clamped under pre-stressing in further seats of the housing. The pressure differential between the exhaust gas mass flow, which drives the turbine, and the pressure in the lubricant chamber of the bearing housing can give rise during the operation of the turbocharger to a displacement of the sealing ring and thereby to a bedding-in of this ring in the annular groove towards the compressor. This bedding-in improves the leak-tightness of the bearing housing. The bedding-in of the sealing ring persists until this ring is contiguous to a circumferential edge in the seat of the bearing housing.

Devices of the type described above designed as shaft seals for sealing the bearing housing of an exhaust-gas turbocharger are described in EP 1 130 220 A and EP 1 507 106 B1.

In the case of the shaft seal as disclosed in EP 1 130 220 A, a sealing ring is supported in a groove of a rotor. During the operation of the exhaust-gas turbocharger, the sealing ring strikes with one face against a flank of the groove. A separation gap formed between the two faces rotating relative to one another seals off the compressor holding compressed air and the bearing of the turbocharger containing oil from one another, forming a largely oil-tight and air-tight gap. Grooves, which are formed into the sealing ring, and ribs which are formed into the bottom of the groove, form multiple sealing faces arranged in the manner of a labyrinth and improve the leak-tightness of the shaft seal.

The device as disclosed in EP 1 507 106 B1 includes a sealing ring embodied as a piston ring having two areas composed of different materials. The first area is produced from a soft, easily abraded material and includes a sliding surface, which interacts with a rotor of the turbocharger. A second area is produced from a highly heat-resistant material. In such a sealing ring, the area composed of highly heat-resistant material can provide the permanent radial pre-stressing required for wedging the sealing ring in a bearing housing of the turbocharger and at the same time the area composed of soft, easily abraded material ideally can assist the desired bedding-in process between the sealing ring and the rotor.

DE 1 247 097 B and EP 1 536 167 A1 describe shaft seals having a sealing ring supported in a groove, in which the heat input into the sealing ring is reduced by a sealing ring face of small dimensions (DE 1 247 097 B: column 1, lines 40 to 47 and FIG. 1; EP 1 536 167 A1: column 10, paragraphs [0082] and [0083]).

### SUMMARY

A device is disclosed for sealing a bearing housing of an exhaust-gas turbocharger, from which a rotor is led into a chamber of the turbocharger subjected to a mass flow, including a sealing ring arranged in a groove of the rotor, a seat, arranged on the bearing housing and on which the sealing ring is pre-stressed and secured by an outward-facing circumferential surface. A radially extending separation gap is annular around an axis of rotation of the rotor and is defined by two superimposed sliding surfaces, a first of which is arranged on a first face of the sealing ring and a second of which is arranged on a first flank of the groove. A depression annularly around the axis is formed into a second flank of the groove. The depression is defined radially outwards by an annular body formed into the rotor. The annular body forms a portion of an external face of the rotor and includes a radially oriented annular edge, which adjoins the external face and which serves to reduce a size of a lapping face, which is produced when the sealing ring strikes against the second groove flank.

### BRIEF DESCRIPTION OF THE DRAWINGS

Exemplary embodiments of the device for sealing the bearing housing of the exhaust-gas turbocharger according to the disclosure are represented schematically and explained in more detail with reference to the figures. In all figures similarly functioning elements are provided with the same reference numerals. In the figures:

FIG. 1 shows a top view of a section taken axially through an exemplary embodiment of an exhaust-gas turbocharger according to the disclosure, in which an outlined device acting as shaft seal is fitted;

FIG. 2 shows an enlarged representation of a shaft seal designed according to an exemplary embodiment of the disclosure and outlined in FIG. 1 prior to commencement of a bedding-in process;

FIG. 3 shows the shaft seal according to FIG. 2 in the operating state on completion of the bedding-in process; and

FIGS. 4, 5 and 6 each show an enlarged representation of one of three exemplary embodiments of the shaft seal according to the disclosure outlined in FIG. 1.

### DETAILED DESCRIPTION

The disclosure relates to a device for sealing a bearing housing of an exhaust-gas turbocharger and an exhaust-gas turbocharger having such a device, features of which are their high reliability and a long service life even under harsher operating conditions of the turbocharger.

In an exemplary embodiment of the device according to the disclosure acting as seal, a depression led annularly around the axis is formed into a flank of a groove facing the turbine of the exhaust-gas turbocharger. The depression is defined radially outwards by an annular body formed into the rotor. The annular body forms a portion of an external face of the rotor and the annular body includes a radially oriented annular edge, which adjoins the external face and which serves to reduce the size of a lapping face, which is produced as the sealing ring strikes against the groove flank.

The reduced lapping face can minimize the heat input into the sealing ring. A heat input into the sealing ring can occur when the sealing ring strikes against the turbine-side flank of the groove sited on a rotor of the turbocharger, and the rotor, through a grinding process, can thereby introduce frictional heat into the sealing ring via the lapping face formed during striking. The sealing ring may possibly strike against the turbine-side groove flank if the pressure of a mass flow containing exhaust gases of an internal combustion engine on the turbine side of the exhaust-gas turbocharger is lower than the pressure in the bearing housing, as is the case in an idling internal combustion engine. Keeping the lapping face small can serve to reduce the friction between the rotor and the sealing ring and only a small amount of heat is introduced into the sealing ring, thereby avoiding additional stressing of the sealing ring. Moreover, the groove flank can be easier to produce and the design of the groove flank can afford a larger interval between the bottom of the groove and the annular edge. This can ensure precise guidance of the sealing ring in the groove whilst at the same time can prevent dirt from a mass flow ducted in the turbocharger from getting into the groove due to the radially outward displacement of the annular edge.

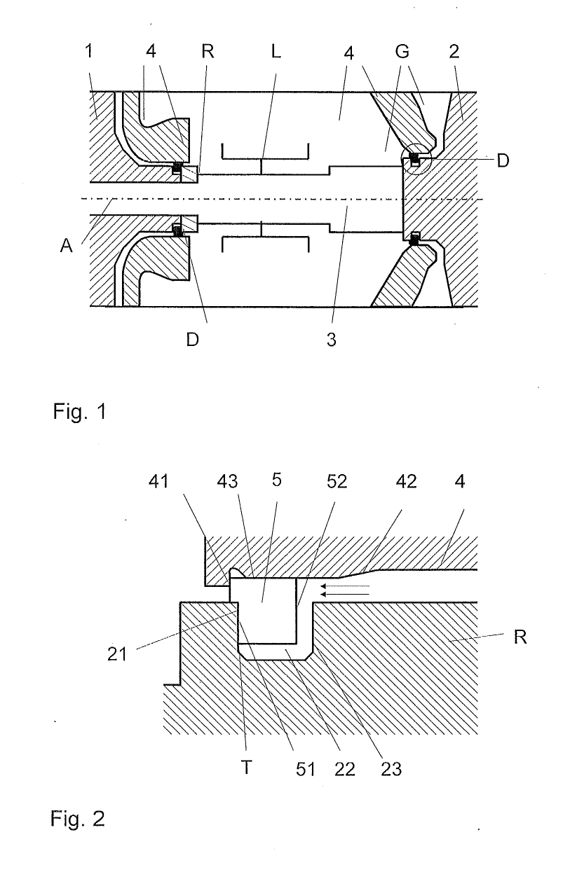

FIG. 1 schematically shows a partial view of an exemplary embodiment of an exhaust-gas turbocharger according to the disclosure having a fixed housing G and a rotor R rotatable about an axis A. A compressor wheel 1, secured on a shaft 3, of an exhaust-gas turbocharger is indicated on the left-hand side of the rotor R. The shaft 3 is in turn connected to a turbine wheel 2 of exhaust-gas turbocharger on the right-hand side. The turbine wheel 2 includes blades (not shown), via which it is driven by an exhaust gas flow produced by an internal combustion engine. The compressor wheel likewise includes blades (not shown).

Axial and radial bearings L, represented only schematically, which absorb the axial and radial forces that occur in the guiding of the rotor R, can be arranged in the area between the two wheels.

The housing G encloses the rotor R and includes a housing part 4 which, embodied as a fixed bearing housing, can accommodate the axial and radial bearings L and a portion of the rotor R and can shield them from other housing parts, in which the turbine wheel 2 of the exhaust gas turbine, subjected to the hot exhaust gas, and the compressor wheel 1, intended for compressing air, are arranged. The axial and radial bearings L can thus be protected from mass flows containing exhaust gas or compressed air, each of which flows have a high pressure, high temperature and high velocity. In order to prevent these mass flows acting in the bearing housing 4 and also to prevent lubricating oil escaping from the bearing housing 4, two shaft seals D, led annularly around the axis of rotation A, one of which is situated on a portion of the bearing housing 4, through which the rotor is led into the compressor, and the other of which is situated on a portion of the bearing housing, through which the rotor is led into the exhaust gas turbine, can be arranged between the bearing housing 4 and the rotor R.

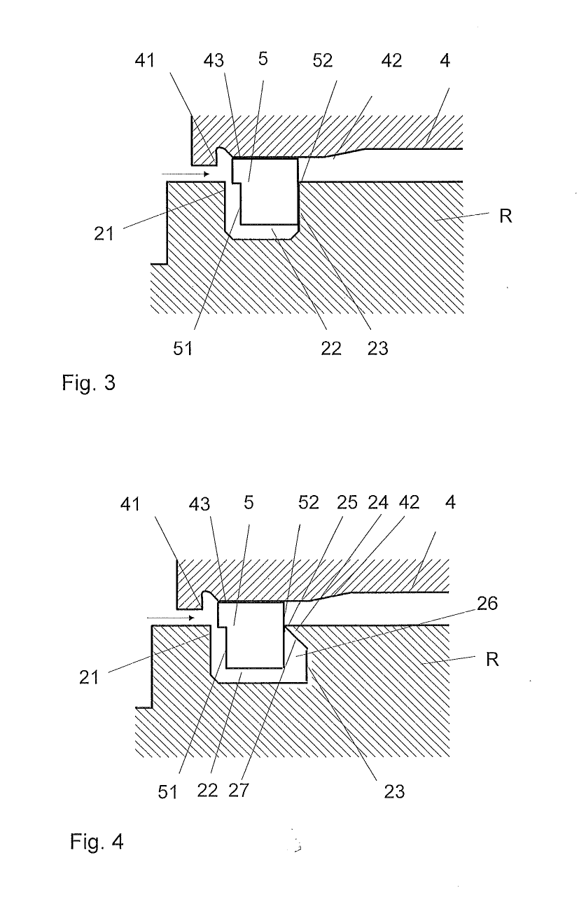

A shaft seal D, according to an exemplary embodiment of the disclosure, is arranged on the turbine side and represented schematically in FIGS. 2 and 3. This seal includes a sealing ring 5, which is arranged in a groove 22 of the rotor R running annularly around the axis of rotation and is embodied as a piston ring. The sealing ring 5 and the groove 22 can each have a predominantly rectangular cross section viewed along the axis of rotation. The shaft seal D includes a seat 43, which is arranged on the bearing housing 4 and on which the sealing ring can be secured by an outward facing circumferential surface so that it can be largely gas and liquid-tight, and a radially extending separation gap T, which is led annularly around the axis of rotation of the rotor R and is defined by two superimposed sliding surfaces. The one sliding surface is arranged on a face 51 of the sealing ring 5, the other on a flank 21 of the groove 22. The superimposed sliding surfaces and the very narrow separation gap T can prevent the exhaust gas mass flow from getting into the bearing housing 4 and oil escaping from the bearing housing 4. At the same time they can allow a rotation of the rotor R, without the sealing ring 5, secured to the bearing housing 4, becoming heated to an inadmissible degree due to sliding friction.

During assembly, the generally metal sealing ring 5 can be inserted into the groove 22 with play. A portion of the rotor R enclosing the turbine wheel 2 can then be pushed into the bearing housing 4 in an axial direction from the right. Because the housing 4 narrows at one or more points 42 or continuously along the insertion path, the sealing ring 5 can be subjected to radial pre-stressing and can be finally wedged in the bearing housing 4 at the seat 43.

On initial commissioning of the seal D, a bedding-in process occurs in the separation gap T. In the process the sealing ring 5 secured to the bearing housing 4 is pressed by the high pressure of the exhaust gas mass flow, indicated by arrows in FIG. 2, against the rotating flank 21 of the groove 22 and is abraded by this as if by a grinding wheel. An annular depression having a sliding surface 51 defining the separation gap T towards the right is ground into the formerly plane face of the sealing ring.

In order to prevent the sealing ring 5 being abraded too deeply in continual operation or even chafed through on completion of the bedding-in process, an axial stop 41 is provided on the bearing housing 4. The axial stop limits the capacity of the sealing ring 5 for axial displacement and thus can improve the sealing effect of the seal D. In the operating state of the turbocharger, therefore, no force can be transmitted in an axial direction under the high pressure of the exhaust gas mass flow in the area of the separation gap T. The force directed at the sealing ring 5 in the direction of the arrow can be counteracted by the axial stop 41.

In fitting the rotor R with the pre-assembled sealing ring 5 it can happen that the sealing ring 5 will bear against a flank 23 of the groove 22 facing the exhaust gas turbine. Under a low pressure of the exhaust gas mass flow, particularly when the engine is idling, this can lead to the bedding-in of the sealing ring on its face identified by the reference numeral 52, which contributes to an additional heat input. A lapping face thereby occurring is determined by the size of the superimposed annular surface portions of the face 52 and the flank 23 subjected to sliding friction.

In each of the disclosed embodiments of the shaft seal according to FIGS. 4 to 6 a depression 26 led annularly around the axis is formed into the flank 23 of the groove 22. The depression undercuts the groove 22 and is defined radially outwards by an annular body 24 formed into the rotor. The annular body 24 forms a portion of an external face of the rotor R and includes a radially oriented annular edge 25 adjoining the external face. This annular edge reduces the size of a lapping face, which is produced as the sealing ring 5 strikes against the groove flank 23. The amount of heat formed due to sliding friction in the grinding process and introduced into the sealing ring 5 can thereby be reduced. At the same time a comparatively large interval exists between the bottom of the groove 22 and the annular edge 25. This can ensure a precise centering of the sealing ring in the groove and can prevent the sealing ring 5 being placed on the rotor R. The radially outward displacement of the annular edge 25 from the bottom of the groove at the same time can also prevent dirt from a mass flow ducted in the turbocharger getting into the groove 22.

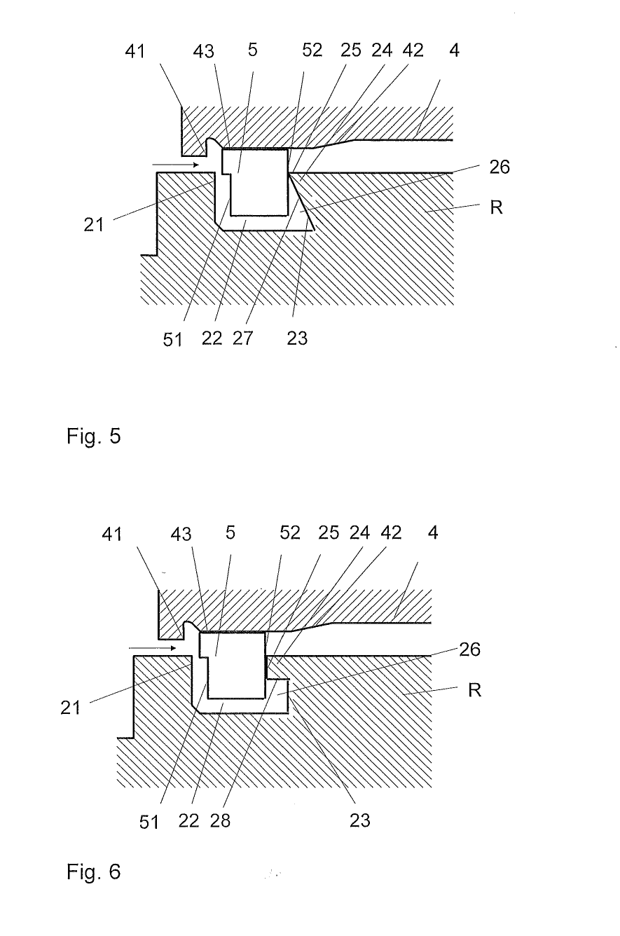

It will be seen from FIGS. 4 and 5 that a sharp annular edge 25, advantageous for specific applications of the exhaust-gas turbocharger, occurs if the depression 26 is defined radially outwards by a tapering chamfer 27 formed into the annular body 24 and led to the annular edge 25. Here the tapering chamfer 27 is led from a radially led portion of the flank 23 (FIG. 4) or from the bottom of the groove 22 to the annular edge 25.

In an exemplary embodiment of the exhaust-gas turbocharger advantageous for other applications, the annular edge can be, in contrast, comparatively blunt. As can be seen from FIG. 6, in this exemplary embodiment, a cylindrical surface 28, formed into the annular body 24 and led to the annular edge 25, defines the depression 26 radially outwards.

In a manner advantageous from a production engineering standpoint, the edge 25 is generally led continuously around the axis of rotation of the rotor R, but it can also be formed by offsets, which can be arranged at intervals from one another in the circumferential direction. They can additionally serve to reduce the lapping face and ensure that the heat input into the sealing ring is further reduced.

Instead of just one edge 25, the annular body 24 can also include two or more edges, which can be arranged substantially coaxially and can be each separated from one another by a depression led around the axis A.

Instead of just one sealing ring 5, the seal D can also include further sealing rings 5, which are arranged in additional grooves and are secured to the bearing housing 4.

Seals according to the disclosure can be provided both on the turbine-side and on the compressor-side bearing housing passage of the rotor. If the requirements demanded of the turbocharger so allow, a seal according to the disclosure can be used solely on the turbine side, whilst the compressor-side rotor passage can be sealed by a seal according to the state of the art.

Thus, it will be appreciated by those having ordinary skill in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

A axis of rotation
D seal
G housing
L axial and radial bearing
R rotor
T separation gap
1 compressor wheel
2 turbine wheel
21 groove flank
22 groove
23 groove flank
24 chamfer
25 edge
26 depression
27 chamfer
28 cylindrical surface
4 bearing housing
41 axial stop
42 radial narrowing
43 seat
5 sealing ring
51,52 faces

What is claimed is:

1. A device for sealing a bearing housing of an exhaust-gas turbocharger, from which a rotor is led into a chamber of the turbocharger subjected to a mass flow, comprising:
a sealing ring arranged in a groove of the rotor;
a seat, arranged on the bearing housing and on which the sealing ring is pre-stressed and secured by an outward-facing circumferential surface; and
a radially extending separation gap, which is annular around an axis of rotation of the rotor and is defined by two superimposed sliding surfaces, a first of which is arranged on a first face of the sealing ring and a second of which is arranged on a first flank of the groove, wherein a depression annularly around the axis is formed into a second flank of the groove, the depression being defined radially outwards by an annular body formed into the rotor, wherein the annular body forms a portion of an external face of the rotor and includes a radially oriented annular edge, which adjoins the external face and which serves to reduce a size of a lapping face, which is produced when the sealing ring strikes against the second flank of the groove.

2. The device as claimed in claim 1, wherein the depression is defined by a tapering chamfer formed into the annular body and leads to the annular edge.

3. The device as claimed in claim 2, wherein the tapering chamfer leads from a bottom of the groove to the annular edge.

4. The device as claimed in claim 1, wherein the depression is defined by a cylindrical surface formed into the annular body, and leads to the annular edge.

5. An exhaust-gas turbocharger having a device as claimed in claim 1, wherein the groove accommodating the sealing ring is arranged on a portion of the rotor carrying a turbine wheel.
